(19) United States
(12) Patent Application Publication
(10) Pub. No.: US 2026/0311224 A1
(43) Pub. Date: Oct. 8, 2026

(54) SYSTEM AND METHOD FOR IMPLEMENTING A CONTRACT LEAKAGE DETECTION AND ANALYSIS PLATFORM USING GENERATIVE ARTIFICIAL INTELLIGENCE AND AGENTS

(71) Applicant: KPMG LLP, New York, NY (US)

(72) Inventors: Mokhtar Chamli, San Diego, CA (US); Sherif AbdElGawad, Sterling, VA (US); Eric Butts, Boston, MA (US); R. Sean Heston, Lawrence, KS (US); Leo Dalle Molle, Cincinnati, OH (US); Sharad Nagariya, Denver, CO (US)

(21) Appl. No.: 19/641,122

(22) Filed: Apr. 7, 2026

Related U.S. Application Data
(60) Provisional application No. 63/784,408, filed on Apr. 7, 2025.

(51) Int. Cl. G06Q 30/04; G06Q 50/18

(52) U.S. Cl. CPC G06Q 30/04; G06Q 50/18

(57) ABSTRACT

An embodiment of the present invention relates to computer-implemented systems and methods for identifying and addressing contract leakage across multiple different procurement relationships. An embodiment of the present invention leverages Generative AI (GenAI) and automated agents to identify discrepancies in invoices, contract pricing, and terms and provide insights. An embodiment of the present invention applies an invoice discrepancy investigation agent configured to check for pricing change orders, amendments, inflation clauses, exchange rates, and volume-based discounts and an adjudication agent to normalize the contract price and re-compare to the invoice price, and provides an interactive user interface identifying flagged items representing potential discrepancies and reasons.

### CROSS REFERENCE TO RELATED APPLICATIONS

The application claims priority to U.S. Provisional Application 63/784,408 (Attorney Docket No. 055089.0000144), filed April 7, 2025, the contents of which are incorporated by reference herein in their entirety.

The application is related to U.S. Patent No. 12,361,457, filed May 19, 2022 and issued July 15, 2025, which claims priority to U.S. Provisional Application No. 63/190,514, filed May 19, 2021, the contents of which are incorporated by reference herein in their entirety.

### FIELD OF THE INVENTION

The present invention relates to systems and methods for contract management and procurement analysis using artificial intelligence and more specifically to a contract leakage detection and analysis platform that leverages generative artificial intelligence and automated agents to identify discrepancies between invoice pricing and contract terms.

### BACKGROUND

Entities in various industries commonly engage in contracts with various vendors, suppliers, contractors, etc. It is common for an entity to have hundreds and hundreds of different contracts in varying formats across a wide range of technology sectors. A procurement contract represents a binding agreement between a purchasing entity and a supplier and describes goods or services expected to be provided along with specifications such as delivery dates, quality control requirements, payment terms, etc. This may include addendums, purchase orders, pricing sheets, statements of work, change orders, invoices, etc. As the procurement process becomes more and more complex, it becomes increasingly difficult to manage and enforce contract terms and related discount, pricing arrangement, payment terms, etc.

Procurement teams oftentimes use creative pricing solutions for services, materials, rental equipment, etc. This may include rate cards and line-item pricing as well as negotiation of special discounts and prices such as but not limited to volume discounts and early payment discounts which may add to the complexity of the overall procurement process.

Complex pricing agreements and high invoice volumes significantly hinder comprehensive verification, leading to unverified charges and errors that may result in substantial unrealized savings, potentially totaling millions. The lack of standardization further adds to inefficiencies and results in inconsistencies.

It would be desirable, therefore, to have a system and method that could overcome the foregoing disadvantages of known systems and that could apply automated detection and analysis of contract leakage resulting in substantial efficiencies that are currently unavailable with existing solutions.

### SUMMARY

According to an embodiment, the invention relates to a computer-implemented system for implementing a contract leakage detection and analysis platform. The system comprises: an input coupled to one or more sources; a memory component that stores and manages contracts and invoices relating to one or more service providers; and a computer server comprising a computer processor and coupled to the input and the memory component, the computer processor configured to perform the steps of: extracting, via the input, pricing information from an invoice stored in a first document format to identify an invoice price, wherein extracting the pricing information comprises parsing the invoice to identify line items, quantities, and unit prices from the first document format; retrieving, via the input, pricing data from an associated contract stored in a second document format to identify a contract price, wherein retrieving the pricing data comprises applying a trained machine learning model to extract pricing terms from the second document format; determining whether the invoice price is equivalent to the contract price by comparing the extracted invoice price against the retrieved contract price; applying an invoice discrepancy investigation agent that is configured to: apply a check for a pricing change order and amendment from the associated contract and determine whether an adjusted contract price applies, wherein the check comprises parsing change order documents to extract effective dates and revised pricing terms; apply a check for an inflation clause in the associated contract and determine whether a recalculated adjusted contract price applies, wherein the check comprises initiating an application programming interface call to an external data source to retrieve a current inflation rate; apply a check for an exchange rate and determine whether a recalculated adjusted contract price applies, wherein the check comprises initiating an application programming interface call to an external data source to retrieve a current exchange rate; and apply a check for volume-based discounts specified in the associated contract and determine whether discount adjustments apply; applying an adjudication agent to normalize the contract price by applying one or more change order adjustments, inflation adjustments, and exchange rate conversions in a defined sequence, and re-compare the normalized contract price to the invoice price; and providing an interactive user interface that identifies one or more flagged items that represent a potential discrepancy and a reason for the potential discrepancy.

According to another embodiment, the invention also relates to a computer-implemented method that implements a contract leakage detection and analysis platform. The method comprises the steps of: extracting, via the input, pricing information from an invoice stored in a first document format to identify an invoice price, wherein extracting the pricing information comprises parsing the invoice to identify line items, quantities, and unit prices from the first document format; retrieving, via the input, pricing data from an associated contract stored in a second document format to identify a contract price, wherein retrieving the pricing data comprises applying a trained machine learning model to extract pricing terms from the second document format; determining whether the invoice price is equivalent to the contract price by comparing the extracted invoice price against the retrieved contract price; applying an invoice discrepancy investigation agent that is configured to: apply a check for a pricing change order and amendment from the associated contract and determine whether an adjusted contract price applies, wherein the check comprises parsing change order documents to extract effective dates and revised pricing terms; apply a check for an inflation clause in the associated contract and determine whether a recalculated adjusted contract price applies, wherein the check comprises initiating an application programming interface call to an external data source to retrieve a current inflation rate; apply a check for an exchange rate and determine whether a recalculated adjusted contract price applies, wherein the check comprises initiating an application programming interface call to an external data source to retrieve a current exchange rate; and apply a check for volume-based discounts specified in the associated contract and determine whether discount adjustments apply; applying an adjudication agent to normalize the contract price by applying one or more change order adjustments, inflation adjustments, and exchange rate conversions in a defined sequence, and re-compare the normalized contract price to the invoice price; and providing an interactive user interface that identifies one or more flagged items that represent a potential discrepancy and a reason for the potential discrepancy.

An embodiment of the present invention provides significant business value by automating and optimizing core finance and procurement processes using advanced AI technologies. The platform enhances data accuracy and integrity, supporting more informed and strategic decision-making. Seamless integration with existing enterprise systems and cloud services ensures minimal operational disruption during deployment. Leveraging AI-driven insights and automation, organizations may achieve increased operational efficiency, reduced costs, and strengthened compliance and governance within finance and procurement operations.

An embodiment of the present invention provides key benefits including rapid deployment leveraging out-of-the-box (OOB) connectors and APIs, facilitating swift implementation of no-code conversational AI contract agents. The platform streamlines contract drafting, review, and approval workflows, significantly reducing turnaround times and reallocating resources to more strategic or critical tasks. Additionally, an embodiment of the present invention offers advanced search capabilities, real-time tracking, and comprehensive analytics, providing enhanced oversight and supporting data-driven decision-making for improved contract management.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary illustration of a commercial leakage platform, according to an embodiment of the present invention.

FIG. 3 is an exemplary a system diagram of a contract leakage detection and analysis platform architecture, according to an embodiment of the present invention.

FIG. 4 is an exemplary flowchart, according to an embodiment of the present invention.

FIG. 5 is an exemplary user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to systems and methods for implementing a contract leakage detection and analysis platform. Contract leakage refers to financial losses that occur when invoiced amounts do not align with negotiated contract terms, pricing agreements, discount structures, and/or other contractual provisions. Such discrepancies may arise from various sources, including failure to apply volume-based discounts, incorrect pricing adjustments, missed early payment discounts, or errors in currency conversion calculations.

An embodiment of the present invention addresses these challenges by providing automated detection and analysis of contract leakage. The contract leakage detection and analysis platform may leverage generative artificial intelligence (GenAI) to automatically analyze and interpret contract terms and pricing details. GenAI integration provides sophisticated and precise examination of contracts, identifying potential leakage points that may not be evident or ascertainable through manual or conventional review processes.

An embodiment of the present invention may implement a set of automated agents to orchestrate sequences of checks and recalculations. Automated agents may streamline the detection process by initiating application programming interface (API) calls to external sources for inflation rates and exchange rates, thereby ensuring access to up-to-date financial data. Automated agents may systematically verify contract terms, such as pricing change orders, amendments, and inflation clauses. Automated agents may further extract detailed pricing information from invoices and compare such information to contract schedules. Automated agents may also flag missing discounts and discrepancies for further review and action.

An embodiment of the present invention may perform normalization of contract prices. Normalization may involve evaluating contract age to determine cumulative inflation adjustments. Normalization may further involve recalculating adjusted contract prices while maintaining the integrity of original contract terms. Adjusted prices based on inflation and exchange rates may be applied without altering original contract terms.

An embodiment of the present invention may provide enhanced adjudication through GenAI and agents. Enhanced adjudication may include normalization of original contract prices and comparison to invoiced rates. Flagged invoices may be highlighted with potential discrepancy reasons, thereby facilitating targeted investigation and expediting resolution.

From a procurement perspective, an embodiment of the present invention may offer advantages including improved accuracy in contract pricing analysis, reduction in manual effort and human errors, and streamlined workflows for faster discrepancy resolution. For legal and compliance teams, the contract leakage detection and analysis platform may provide a framework for ensuring contract adherence, enhanced ability to detect and address financial discrepancies, and support for drafting comprehensive contract terms and amendments. Other uses and applications may be supported.

An embodiment of the present invention may be implemented in various architectures including client-hosted software-as-a-service; entity-hosted software-as-a-service and service-as-a-software.

For the various architectures, client needs may be considered including: AI-enabled capabilities ownership, operation model; data / sources sharing; client priorities; commercial model, etc.

For AI-enabled capabilities ownership, a client may prioritize ownership of AI-enabled capabilities for contract leakage detection, viewing this use case as a foundational component for developing agentic workflows within their broader AI transformation strategy. The client may want to invest capital in building and amortizing IT assets specifically for this purpose. Their established operating model, governance structure, and dedicated resources may support the execution and management of analytics outputs and recovery initiatives. The client may be amenable to sharing relevant data sources, including contracts, invoices, purchase orders, and invoice attachments, outside their internal environment when necessary. Core priorities may encompass the deployment of AI-enabled capabilities for contract leakage for automation for broader AI transformation, utilization of a proprietary SaaS tool for internal analytics and insights, and achievement of outcome-based cost reduction. The commercial model may involve leveraging an operating framework and team to deliver analytics and insights that drive value-based recovery efforts.

Engagement models may consider various factors including: AI-enabled capabilities ownership, infrastructure set-up; custom solution architecture, core components, pre-built AI contract leakage accelerators, custom AI leakage capabilities, contract leakage analytics and insights, contract leakage recovery outcome service, etc.

An embodiment of the present invention may deploy advanced AI-enabled capabilities for contract leakage detection and analysis. The infrastructure may include a dedicated landing zone with integrated products, services, and components. A comprehensive, modular architecture may include foundational building blocks designed to accelerate solution development. The platform may feature pre-built AI contract leakage accelerators tailored to industry and function-specific use cases, including defined workflows, data models, ontologies, business rules, AI agents, etc. In addition, an embodiment of the present invention may support the development of custom AI capabilities to address client-specific requirements across diverse customer and contract portfolios. An embodiment of the present invention may deliver robust analytics and actionable insights to identify potential savings, while the operating model and specialized team execute on these insights to achieve value-based recovery outcomes.

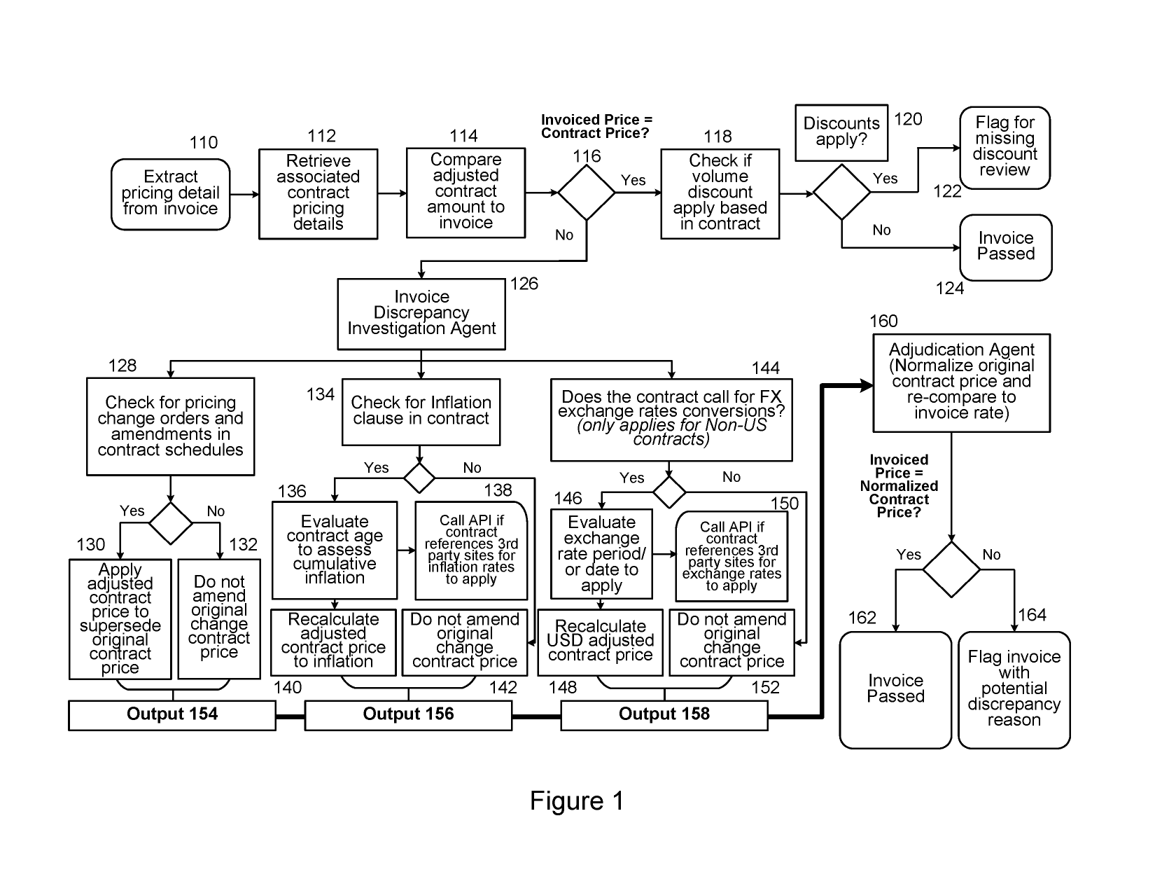

FIG. 1 is an exemplary flowchart, according to an embodiment of the present invention. FIG. 1 illustrates a leakage detection and analysis orchestration process that includes multiple decision points and agent-based operations for detecting and resolving contract leakage. The process encompasses initial price comparison operations, an Invoice Discrepancy Investigation Agent that performs checks for change orders, inflation clauses, and exchange rate conversions, and an Adjudication Agent that normalizes contract prices for final comparison against invoice rates. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

As shown in FIG. 1, a process may start at step 110 where pricing details may be extracted from an invoice or group of invoices. At step 112, associated contract pricing details may be retrieved. At step 114, an adjusted contract amount may be compared to the invoice. If the invoice price and the contract price match at step 116, a volume check may be applied to determine whether a volume discount applies based on the contract, at step 118. If discounts apply at step 120, the invoice may be flagged for a missing discount review, at step 122. If discounts do not apply, at step 120, the invoice may be considered passed, at step 124.

If the invoice price and the contract price do not match at step 116, an Invoice Discrepancy Investigation Agent may be executed, at step 126. The agent may check for pricing change orders and amendments in contract schedules, at step 128. If yes, an adjusted contract price may be applied to supersede an original contract price, at step 130. If no, the original change contract price may be left intact with no changes, at step 132.

The agent may check for an inflation clause in the contract, at step 134. If yes, a contract age may be evaluated to assess cumulative inflation to apply, at step 136. Here, an API may be called if the contract references third party sites for inflation rates to apply, at step 138. At step 140, an adjusted contract price may be recalculated for inflation. If no, the original change contract price may be left intact with no changes, at step 142.

The agent may check to determine whether the contract calls for FX exchanges rates conversion, at step 144. This may apply to non-US contracts. If yes, an exchange rate period or date may be evaluated for applicability, at step 146. An API may be called if the contract references third party sites for exchange rates to apply, at step 150. At step 148, an adjusted contract price may be recalculated. If no, the original change contract price may be left intact with no changes, at step 152.

The invoice discrepancy investigation agent may perform additional discrepancy checks. For example, certain contracts in specific industries may involve other checks that may be applied. The checks may be performed in parallel or in sequence/order.

Outputs 154, 156 and 158 may be provided to an Adjudication Agent at 160. The Adjudicator Agent may be applied to normalize original contract price and re-compare the price to an invoice rate. If the invoiced price and normalized contract price are the same, the invoice may be considered passed, at step 162. If not, the invoice may be flagged with a potential discrepancy reason, at step 164.

The flagged invoices may be communicated through an interactive user interface through a secure communication network. The flagged invoices may include a potential discrepancy reason. In addition, other information may be provided to facilitate resolution. The flagged invoices may be further enhanced with additional information or insights through GenAI to automate and/or facilitate resolution.

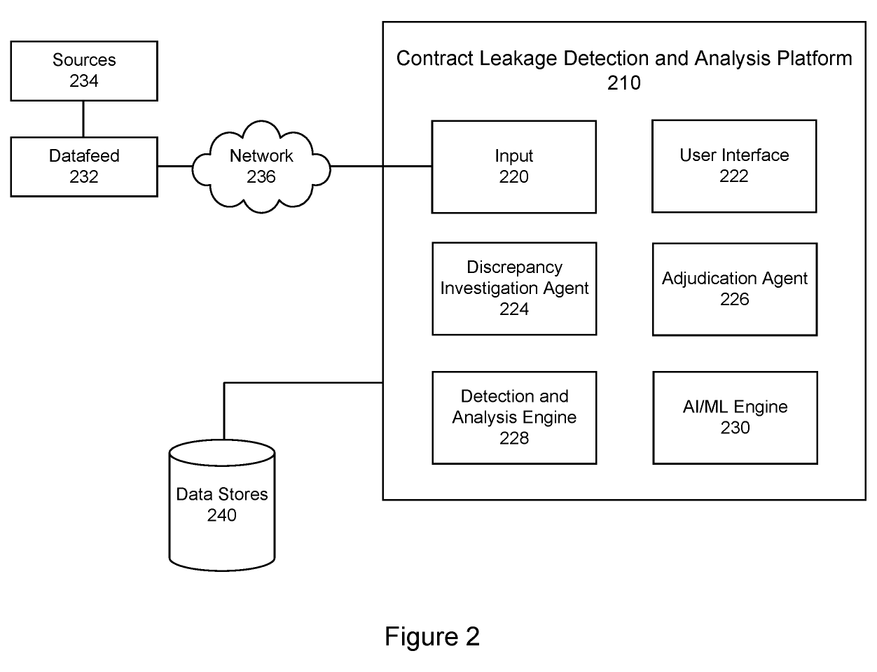

FIG. 2 is an exemplary system diagram implementing a Contract Leakage Detection and Analysis Platform, according to an embodiment of the present invention. Contract Leakage Detection and Analysis Platform 210 may include Input 220, User Interface 222, Discrepancy Investigation Agent 224, Adjudication Agent 226, and Detection and Analysis Engine 228, AI/ML Engine 230.

Input 220 may access data sources including data feeds represented by 232 from Sources 234, including internal and external sources. Input 220 may access data relating to various vendors as well as confidential proprietary information, e.g., prior engagements, engagement data, performance data, metrics, analytics, etc. Data may be communicated through a communication network as shown by Network 236. Data may be stored at Data Stores 240 as well as other storage components. Other integrations may be supported.

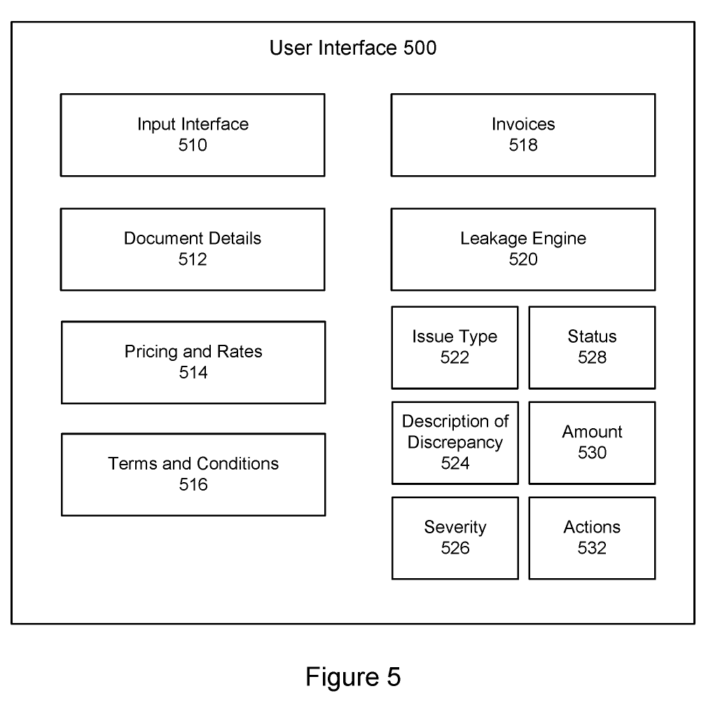

User Interface 222 provides interactive interfaces that may be tailored to specific use cases, vendors, applications, industries, etc. User Interface 222 may support various types of adjudications enhanced by GenAI and agents. For example, User Interface 222 may communicate invoices that have passed and invoices that have been flagged for review. In addition, normalized contract prices may be compared to invoices rates through User Interface 222. Other comparisons may be supported. With an embodiment of the present invention, User Interface 222 may support communications with various users, systems, etc. Additional details are provided in FIG. 5 below.

An embodiment of the present invention may provide a set of agents to perform various tasks and functions. While FIG. 2 illustrates exemplary agents, an embodiment of the present invention is not limited and may be applied to a wide range of agents to support use cases, applications and systems. Discrepancy Investigation Agent 224 orchestrates a sequence of checks and recalculations. Discrepancy Investigation Agent 224 systematically verifies contract terms and initiates API calls to external sources for inflation rates, exchange rates, and other financial data. Other discrepancy checks may be performed.

Adjudication Agent 226 normalizes contract prices by evaluating contract age (or other determination), recalculating adjusted contract prices, and applying adjusted prices based on inflation and exchange rates. For example, Adjudication Agent 226 may consolidate adjustments from Discrepancy Investigation Agent 224 to generate normalized contract prices for comparison against invoice rates. Other factors and considerations may be applied in the normalization process.

Detection and Analysis Engine 228 may include various processing components that perform detection of potential contract leakage and related analysis. Detection and Analysis Engine 228 may perform compliance functions to support contract adherence and also address financial and other discrepancies.

AI/ML Engine 230 may integrate artificial intelligence and machine learning algorithms to analyze training data from prior contracts and engagements, results from client interactions and/or other analytics to develop models that refine and improve on detection and analysis. AI/ML 230 may apply various neural networks and algorithms to recognize patterns / classifications that may be applied to generate and refine potential opportunities as well as identify targeted and timely client interaction opportunities. AI/ML Engine 230 may support various neural networks that recognize relationships between one or more variables.

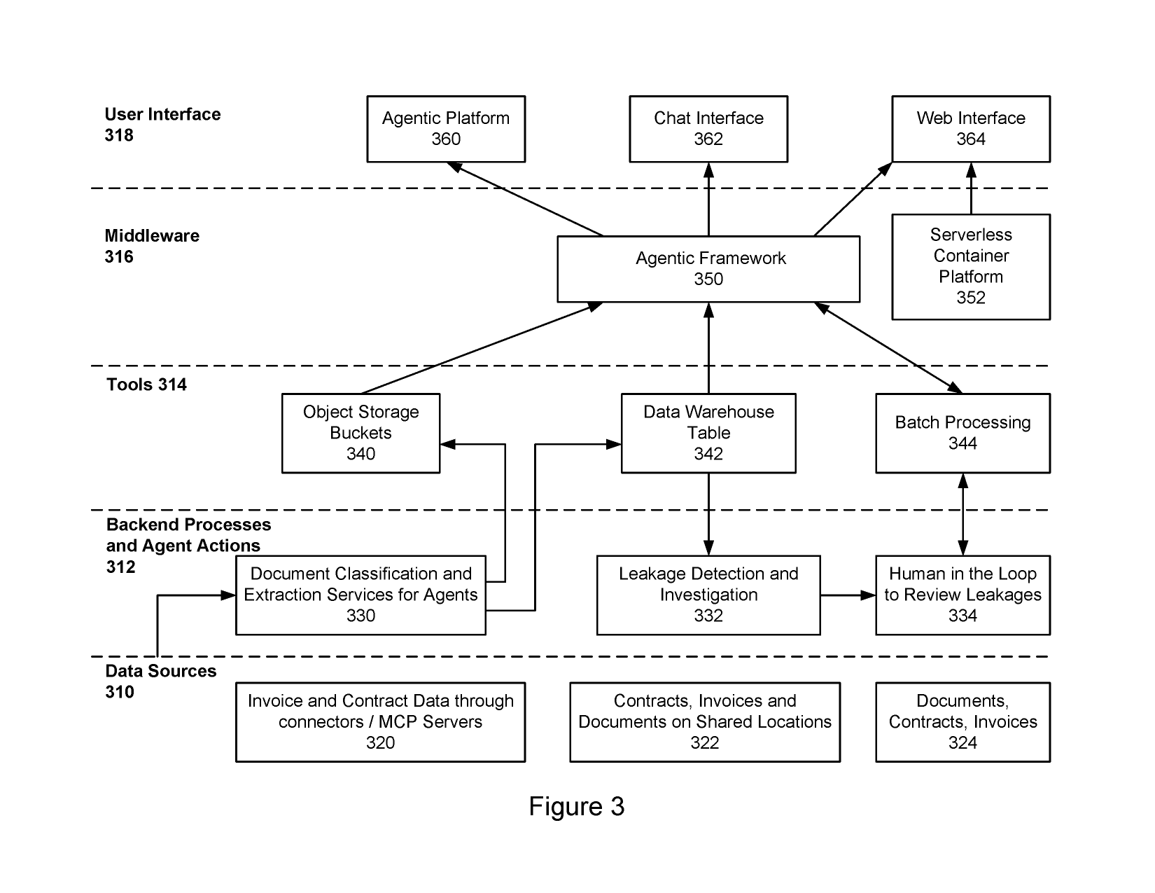

FIG. 3 is an exemplary a system diagram of a contract leakage detection and analysis platform architecture, according to an embodiment of the present invention.

As shown in FIG. 3, a system diagram illustrates a platform architecture for the contract leakage detection and analysis platform. The platform architecture may be organized into multiple layers that facilitate the processing and analysis of contract and invoice data for leakage detection. The layered architecture may enable separation of operations relating to data ingestion, processing, orchestration, and user interaction functions. The platform architecture may include Data Sources 310, Backend Processes and Agent Actions 312, Tools 314, Middleware 316 and User Interface 318.

Data Sources 310 provide data input to the contract leakage detection and analysis platform. Data Sources 310 may include multiple data input channels that supply contract documentation, invoice records, and related data to the platform for processing. Data Sources 310 may receive data from internal enterprise systems, external data providers, and document repositories. Data Sources 310 may support various data formats and protocols to enable integration with diverse data sources across an organization's technology landscape.

Invoice and Contract Data Through Connectors / MCP Servers 320 provide invoice and contract data through connectors and MCP servers. The connectors may support various protocols and data formats to enable integration with enterprise resource planning systems, procurement management systems, and accounts payable systems. Invoice and Contract Data Through Connectors / MCP Servers 320 may retrieve invoice data including line items, quantities, unit prices, and discounts, as well as contract data including pricing terms, rate schedules, and amendment histories. The connector-based data access mechanisms may enable real-time or near-real-time data retrieval to support timely detection of contract leakage events.

Contracts, Invoices and Documents on Shared Locations 322 stores and makes available contracts, invoices, and documents on various shared locations. Contracts, Invoices and Documents on Shared Locations 322 may provide access to document repositories where contract files and invoice records are maintained in file-based and other formats. The shared locations may include network file shares, cloud storage services, and document management systems that store contract documentation in multiple formats, such as PDF, Word, or scanned images. Contracts, Invoices and Documents on Shared Locations 322 may enable the contract leakage detection and analysis platform to access documents that are not maintained within structured enterprise systems.

Documents, Contracts, Invoices 324 provides additional document, contract, and invoice data sources. Documents, Contracts, Invoices 324 may supplement the data obtained through Invoice and Contract Data Through Connectors / MCP Servers 320 and Contracts, Invoices and Documents on Shared Locations 322. Documents, Contracts, Invoices 324 may include data from legacy systems, archived records, and/or third-party data providers that maintain contract and invoice information relevant to the leakage detection and analysis operations.

The connector-based data access mechanisms supported by Data Sources 310 may enable the contract leakage detection and analysis platform to aggregate data from multiple sources into a unified data set for processing. The connector-based data access mechanisms may support authentication and authorization controls to ensure that data access complies with security policies and access restrictions. The connector-based data access mechanisms may further support data transformation operations that normalize data from disparate sources into consistent formats suitable for processing by Backend Processes and Agent Actions 312.

Backend Processes and Agent Actions 312 handles processing operations for the contract leakage detection and analysis platform. Backend Processes and Agent Actions 312 may execute detection and analysis operations, including the checks, normalization and other operations performed by various agents. For example, Backend Processes and Agent Actions 312 may coordinate document classification, data extraction, and discrepancy investigation functions. Backend Processes and Agent Actions 312 may further provide human oversight capabilities that enable review of identified leakages by procurement or finance personnel.

Document Classification and Extraction Services for Agents 330 performs document classification and extraction operations. Document Classification and Extraction Services for Agents 330 may process contracts, invoices, and documents received from Data Sources 310 to categorize document types and extract relevant data elements. Document Classification and Extraction Services for Agents 330 may classify incoming documents into categories such as Master Service Agreements, Addendums, Statements of Work, Change Orders, pricing sheets, and invoices based on document structure, content, and metadata characteristics.

Document Classification and Extraction Services for Agents 330 may apply document parsing techniques to extract structured data from unstructured document formats. The extraction operations may identify pricing terms, rate schedules, discount structures, inflation clause provisions, and exchange rate specifications from contract documents. The extraction operations may further identify line items, quantities, unit prices, and total amounts from invoice documents. The extracted data may be stored in structured formats that support subsequent processing by agents such as a discrepancy investigation agent and an adjudication agent. For example, automated agents may provide classified and extracted data in formats suitable for agent processing.

Leakage Detection and Investigation 332 executes detection and analysis operations to identify potential contract leakage events. For example, Leakage Detection and Investigation 332 may perform various checks and perform the normalization and comparison operations. Leakage Detection and Investigation 332 may process invoice and contract data from a Data Warehouse Table 342 to identify pricing discrepancies using the comparison logic. When discrepancies are identified, the Leakage Detection and Investigation 332 may perform automated checks for change orders, inflation clauses, and exchange rate provisions. Leakage Detection and Investigation 332 may generate detection results identifying invoices with potential leakage events, including discrepancy reasons, quantified financial impacts, and supporting documentation. The detection results may be stored and provided to user interfaces for presentation to users.

Human in the Loop to Review Leakages 334 provides human oversight for identified leakages. Human in the Loop to Review Leakages 334 may enable personnel to review flagged invoices and discrepancy reasons through a user interface. Human in the Loop to Review Leakages 334 may enable users to validate or override determinations made. User determinations may be captured and stored.

Human in the Loop to Review Leakages 334 may support escalation workflows that route flagged invoices to appropriate personnel based on discrepancy characteristics such as amount thresholds, vendor classifications, or contract types. Human in the Loop to Review Leakages 334 may provide feedback mechanisms that enable user determinations to inform a leaning algorithm or engine, improving detection accuracy over time.

Tools 314 provide storage and processing capabilities for the contract leakage detection and analysis platform. Tools 314 may include object storage capabilities for storing unstructured data such as contract documents and invoice images. Tools 314 may further include data warehouse capabilities for storing structured data that supports analytical queries and reporting operations. Tools 314 may additionally include batch processing capabilities for handling large-volume processing operations. Tools 314 may work in conjunction with data storage components to provide comprehensive data management capabilities for the platform.

Object Storage Buckets 340 stores unstructured data such as contract documents, invoice images, and supporting documentation in native file formats. Object Storage Buckets 340 may maintain document versions and metadata for retrieval during discrepancy investigation operations and may support scalable storage capacity for growing document volumes.

Object Storage Buckets 340 may receive documents from Data Sources 310 for storage and processing by Backend Processes and Agent Actions 312. Documents may be stored in various formats such as PDF, Word, Excel, and scanned images for processing by Document Classification and Extraction Services for Agents 330. Object Storage Buckets 340 may also store intermediate processing results and analysis outputs generated during leakage detection operations.

Data Warehouse Table 342 provides structured data storage and retrieval capabilities. Data Warehouse Table 342 may store extracted contract data, invoice data, and discrepancy analysis results in structured formats supporting analytical queries and reporting. Data Warehouse Table 342 may maintain relational data structures associating invoices with corresponding contracts, vendors, and discrepancy investigation outcomes.

Data Warehouse Table 342 may provide data to Leakage Detection and Investigation 332 and store detection results including flagged invoices, discrepancy reasons, quantified financial impacts, and resolution status. Data Warehouse Table 342 may support query operations enabling User Interface 318 to retrieve and display analysis results, as well as aggregation queries generating summary statistics and trend analyses across contract portfolios.

Batch Processing 344 handles batch processing operations for the contract leakage detection and analysis platform. Batch Processing 344 may process large volumes of contracts and invoices in scheduled or on-demand batch operations, enabling analysis of invoice populations spanning extended time periods or multiple vendor relationships within a single processing run.

Batch Processing 344 may communicate with the Human in the Loop to Review Leakages 334 to queue flagged invoices for human review. Batch Processing 344 may generate reports summarizing processing outcomes, including counts of invoices processed, passed, and flagged for review, and may support parallel processing to reduce overall processing time.

Middleware 316 provides orchestration capabilities for the contract leakage detection and analysis platform. Middleware 316 may coordinate the various processing functions performed by Backend Processes and Agent Actions 312 and manage data flows between the platform layers. Middleware 316 may include an Agentic Framework 350 that serves as a central orchestration component connecting the processing layer to the tools layer and the user interface layer. Middleware 316 may further include serverless container capabilities that support scalable execution of processing operations.

Agentic Framework 350 serves as an orchestration component for the contract leakage detection and analysis platform. Agentic Framework 350 may coordinate the various processing functions performed by Backend Processes and Agent Actions 312 and manage data flows between the platform layers. Agentic Framework 350 may connect to Tools 314 to access storage and processing capabilities including Object Storage Buckets 340, Data Warehouse Table 342, and Batch Processing 344. Agentic Framework 350 may manage data flow between the automated agents and Tools 314. Agentic Framework 350 may further connect to User Interface 318 to provide access to processing results and receive analysis requests from users.

Agentic Framework 350 may support bidirectional communication with User Interface 318 to enable interactive analysis operations. Agentic Framework 350 may receive analysis requests from users and invoke appropriate processing functions, returning results for presentation through conversational interfaces, web interfaces, and agentic platform interfaces.

Serverless Container Platform 352 provides serverless container capabilities for deploying Agentic Framework 350. Serverless Container Platform 352 may enable scalable execution of processing operations byautomatically adjusting computing resources based on processing demand without requiring dedicated server infrastructure. Serverless Container Platform 352 may connect to Web Interface 364 to support web-based access to the contract leakage detection and analysis platform and may host web application components and API endpoints for programmatic access.

An embodiment of the present invention may be built on cloud services to ensure seamless integration with existing enterprise systems. The cloud services may provide infrastructure components and managed services for artificial intelligence, machine learning, and data analytics that enhance the contract leakage detection and analysis capabilities.

User Interface 318 provides user access to the contract leakage detection and analysis platform. The User Interface 318 may offer multiple interface options for user interaction, including agentic platform interfaces, chat interfaces, and web interfaces. User Interface 318 may connect to the Middleware 316 to access processing results and to initiate analysis operations.

Agentic Platform 360 provides an interface for user interaction with the automated agents of the contract leakage detection and analysis platform. Agentic Platform 360 may connect bidirectionally with Agentic Framework 350 to enable users to initiate analysis operations and receive detection results, discrepancy reasons, and flagged invoice information.

Chat Interface 362 provides conversational interaction capabilities for the contract leakage detection and analysis platform. Chat Interface 362 may enable users to interact with the Contract Leakage Detection and Analysis Platform 210 through natural language conversations. Chat Interface 362 may connect to Agentic Framework 350 to invoke processing functions based on user queries. Chat Interface 362 may process natural language queries regarding contract leakage, invoice discrepancies, and vendor pricing to retrieve relevant data and present analysis results in conversational formats.

An embodiment of the present invention may integrate with cloud-based artificial intelligence services for building conversational AI agents. The conversational AI agents may provide natural language interfaces that enable users to interact with the platform through chat-based conversations, interpret user queries, invoke appropriate processing functions through Agentic Framework 350, and present results in conversational formats.

Web Interface 364 provides browser-based access to the contract leakage detection and analysis platform. Web Interface 364 may connect to Agentic Framework 350 and Serverless Container Platform 352 to access processing results and platform capabilities. Web Interface 364 may present structured views of contract leakage detection results including flagged invoices, discrepancy summaries, and detailed invoice information with discrepancy reasons and adjustment factors. Web Interface 364 may provide filtering and sorting capabilities based on criteria such as discrepancy type, amount, vendor, contract, or date range. Web Interface 364 may provide dashboard views with summary statistics and visualizations of leakage detection outcomes, drill-down capabilities for investigating specific discrepancies, and export capabilities for downloading detection results.

An embodiment of the present invention may provide multiple interfaces for user interaction, as shown by Chat Interface 362 and Web Interface 364. The availability of multiple interface types enable users to select the interaction mode that aligns with their preferences and task requirements. Users who prefer conversational interaction may access the platform through Chat Interface 362 to submit natural language queries and receive conversational responses. Users who prefer structured navigation may access the platform through Web Interface 364 to browse detection results, apply filters, and view detailed discrepancy information through graphical interface elements.

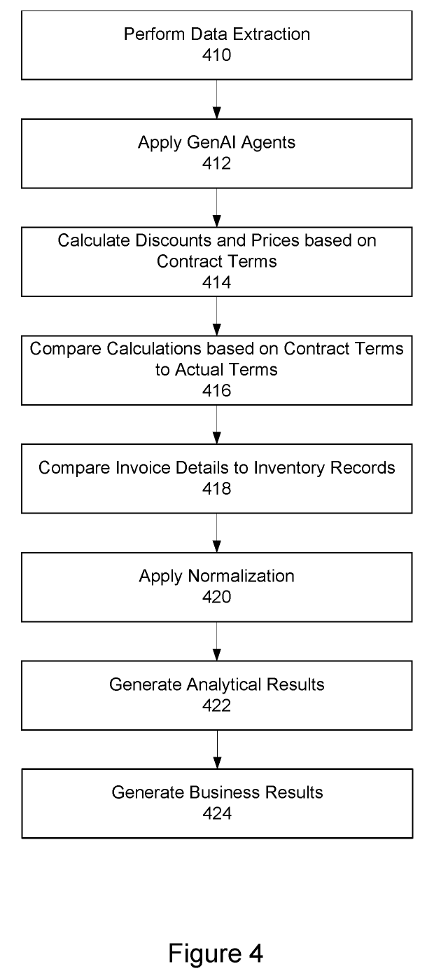

FIG. 4 is an exemplary flowchart, according to an embodiment of the present invention. As shown in FIG. 4, a flowchart illustrates a contract leakage detection and analysis process that leverages GenAI agents to analyze contract and invoice data and identify discrepancies between contract terms and actual invoiced amounts.

At step 410, data extraction is performed. The data extraction may involve extracting data from multiple source types including contract files, invoices, and inventory and accounting systems. Contract files may include Master Service Agreements, Addendums, Statements of Work, Change Orders, pricing sheets, and commercial terms documentation. Invoice data may include items purchased, quantities, prices, and discounts. Inventory and accounting system data may include items received, quantity information, and date information.

At step 412, GenAI agents are applied to analyze and interpret the extracted data. GenAI agents may process the contract documentation and invoice data to identify pricing terms, discount structures, and other contractual provisions relevant to leakage detection. GenAI agents may interpret contract language to determine the applicability of pricing provisions to specific invoice line items. GenAI agents may further identify relationships between contract documents, such as associations between Master Service Agreements and related Statements of Work or Change Orders. The analysis performed by the GenAI agents may enable sophisticated examination of contracts that identifies potential leakage points that may not be evident through rule-based analysis alone.

At step 414, discounts and prices are calculated based on contract terms. This may involve applying the pricing provisions and discount structures identified by the GenAI agents to determine the expected pricing for invoiced items. For example, the calculations may include application of volume-based discounts based on quantities reflected in the invoice data. The calculations may further include application of early payment discounts, promotional pricing arrangements, and other discount types specified in the contract terms.

At step 416, calculations based on contract terms are compared to actual terms to identify potential discrepancies. The comparison may evaluate whether the calculated pricing matches the pricing reflected in the invoice data. The comparison may identify invoices where the invoiced amounts exceed the amounts that should have been charged under the contract terms. The comparison may further identify invoices where applicable discounts were not applied or were applied incorrectly. Discrepancies may be flagged for further investigation.

At step 418, invoice details are compared to inventory records to verify that items received match what was invoiced. The comparison may involve matching invoice line items against corresponding inventory receipt records to confirm that the purchasing entity received the goods or services reflected in the invoice. The comparison may evaluate quantities, item descriptions, and receipt dates to determine whether the invoiced items correspond to actual deliveries documented in the inventory and accounting systems. Verification may identify invoices that reflect items not received, quantities that exceed actual deliveries, or items that were received but not invoiced.

The comparison may access inventory data, including items received, quantity information, and date information from inventory and accounting systems. An embodiment of the present invention may correlate invoice line items with inventory receipt records based on item identifiers, descriptions, or other matching criteria. The correlation may account for variations in item naming conventions between invoice systems and inventory systems. An embodiment of the present invention may apply fuzzy matching techniques to identify corresponding records when exact matches are not available due to data entry variations or system differences.

The verification process may identify discrepancies where invoiced quantities exceed received quantities. Such discrepancies may indicate billing errors, shipment shortfalls, or potential fraudulent invoicing. The verification process may further identify discrepancies where received quantities exceed invoiced quantities, which may indicate unbilled deliveries or invoice processing delays. An embodiment of the present invention may flag invoices with inventory discrepancies for review through a Human in the Loop process.

An embodiment of the present invention may detect duplicate invoicing and payments as a type of contract leakage. Duplicate invoicing may occur when a supplier submits multiple invoices for the same goods or services. Duplicate payments may occur when the same invoice is processed for payment multiple times. An embodiment of the present invention may analyze invoice records to identify potential duplicates based on invoice numbers, amounts, dates, vendor identifiers, and/or line item details.

The detection of duplicate invoicing may involve comparing incoming invoices against historical invoice records. An embodiment of the present invention may apply configurable matching rules that define criteria for identifying potential duplicates, including exact match requirements for certain fields and tolerance ranges for other fields. The detection of duplicate payments may involve analyzing payment records in conjunction with invoice records to identify instances where the same invoice was paid multiple times. Potential duplicate payments may be flagged for review to determine whether recovery actions are warranted.

At step 420, normalization is applied to adjust contract prices for factors such as inflation and exchange rates. The normalization process consolidates the adjustment operations performed by agents, such as a Discrepancy Investigation Agent and an Adjudication Agent. The normalization process generates adjusted contract prices reflecting cumulative inflation adjustments and exchange rate conversions for contracts denominated in foreign currencies. The normalization process preserves original contract pricing in a data store while generating normalized pricing for comparison purposes. The adjustment calculations, including inflation index values, exchange rate values, and resulting normalized prices, are documented to support review of flagged discrepancies and facilitate resolution of pricing disputes. Adjustments are applied in a defined sequence: change order adjustments first, followed by inflation adjustments, and finally exchange rate conversions.

At step 422, analytical results are generated based on the comparisons and calculations performed in the preceding steps. The analytical results may include quantified discrepancy amounts representing the difference between invoiced pricing and normalized contract pricing. The analytical results may further include categorization of discrepancies by type, such as missing volume discounts, incorrect inflation adjustments, exchange rate errors, or duplicate invoicing. An embodiment of the present invention may aggregate results across invoice populations to generate summary statistics including total discrepancy amounts, discrepancy counts by category, and discrepancy rates by vendor or contract. The analytical results may be stored in a data storage component, such as data warehouse table, for subsequent retrieval and reporting through an interface, such as a User Interface or a Web Interface.

At step 424, business results are generated based on the analytical results. The business results may include actionable insights regarding contract leakage, discrepancies, and savings opportunities. The business results may identify invoices where recovery actions may be warranted and contracts where renegotiation may be beneficial. The business results may quantify potential savings opportunities, prioritize remediation efforts based on discrepancy magnitude and likelihood of successful recovery, and provide recommendations for process improvements to reduce future leakage events.

An embodiment of the present invention may train models to extract and interpret contract scoping fields from contract documentation. The model training may be performed by an AI/ML Engine using training data derived from prior contracts and engagements. The trained models may identify and extract fields such as contract effective dates, expiration dates, pricing terms, discount structures, inflation clause provisions, exchange rate specifications, and volume threshold definitions. The trained models may further interpret the extracted fields to determine the applicability of pricing provisions to specific invoice line items and to calculate expected pricing based on contract terms.

The model training may involve supervised learning techniques where labeled examples of contract documents are used to train the models to recognize and extract relevant fields. The labeled examples may include annotations that identify the locations and values of contract scoping fields within document structures. The AI/ML engine may apply the trained models to new contract documents to extract scoping fields without requiring manual data entry. The extraction accuracy may improve over time as additional labeled examples are incorporated into the training data and as feedback from a human in the loop review process may be used to refine the models.

An embodiment of the present invention may support multiple invoice matching techniques for comparing invoice data against contract pricing and inventory records. The invoice matching techniques may include exact matching where invoice line items are matched to contract pricing provisions based on identical item identifiers, descriptions, or codes. The invoice matching techniques may further include fuzzy matching where invoice line items are matched to contract pricing provisions based on similarity measures that account for variations in naming conventions, abbreviations, or data entry inconsistencies.

An embodiment of the present invention may configure multiple invoice matching techniques. The invoice matching techniques may be selected and configured based on the characteristics of the client's contract and invoice data. The invoice matching techniques may include unit price matching where invoice unit prices are compared against contract rate schedules. The invoice matching techniques may include quantity-based matching where invoice quantities are evaluated against volume discount thresholds specified in contracts. The invoice matching techniques may include date-based matching where invoice dates are compared against contract effective dates and change order effective dates to determine applicable pricing provisions. The invoice matching techniques may include vendor-based matching where invoice vendor identifiers are correlated with contract vendor records to associate invoices with corresponding contracts. The invoice matching techniques may include line item description matching where invoice line item descriptions are compared against contract service or product descriptions using text similarity algorithms.

FIG. 5 is an exemplary user interface, according to an embodiment of the present invention. As shown in FIG. 5, a User Interface 500 for the contract leakage detection and analysis platform provides an integrated display for managing contract data, invoice information, and leakage detection results.

Input Interface 510 receives data from various sources and enables users to upload contract documents, invoice files, and supporting documentation for processing.

Document Details 512 component displays metadata associated with contract documents including contract details (e.g., identifier, name, start date, end date, status), service description, payment terms, service level agreements, etc.

A Pricing and Rates 514 component presents pricing information and rate schedules extracted from contracts, including unit prices, tiered pricing structures, and volume discount thresholds.

A Terms and Conditions 516 component displays contractual provisions including inflation clauses, exchange rate specifications, payment terms, and discount eligibility criteria.

An Invoices 518 component displays invoice records including invoice numbers, dates, vendor identifiers, line item details, quantities, unit prices, and verification status.

A Leakage Engine 520 component performs contract leakage detection and analysis operations and displays flagged invoices along with associated discrepancy information. Leakage Engine 520 may provide details relating to Issue Type 522, Description of Discrepancy 524, Severity 526, Status 528, Amount 530 and Actions 532.

Issue Type 522 component categorizes discrepancies into types such as pricing mismatch, service scope, etc.

Description of Discrepancy 524 component provides explanatory text describing the specific pricing variance, the contract terms not properly applied, or the calculation error that resulted in the discrepancy.

Severity 526 component classifies discrepancies into severity levels such as high, medium, or low based on factors including the discrepancy amount and percentage variance from expected pricing.

Status 528 component displays the current status of each discrepancy, indicating whether a flagged invoice is open, pending review, under investigation, awaiting supplier response, resolved, or closed.

Amount 530 component presents the monetary value associated with each discrepancy, representing the difference between the invoiced amount and the normalized contract price.

Actions 532 component provides options for users to perform operations such as View, Resolve and Dismiss. Other actions may include initiate resolution workflows, assign discrepancies to investigators, escalate discrepancies, generate dispute communications, mark discrepancies as resolved, etc.

The contract leakage detection and analysis platform may provide technical improvements to computer-based contract management systems. The technical improvements may include automated extraction of pricing information from disparate document formats, real-time normalization of contract prices based on dynamically retrieved external data, and systematic orchestration of multiple verification agents to identify pricing discrepancies that would otherwise require extensive manual review. The platform may reduce processing time and computational resources required to analyze large volumes of invoices against complex contract terms by applying trained machine learning models that identify patterns predictive of leakage events. The platform may further improve the accuracy of discrepancy detection by automatically retrieving current inflation rates and exchange rates through API calls to external sources, thereby ensuring that contract price normalizations reflect up-to-date financial data rather than stale or manually maintained reference values. The integration of various investigation and adjudication agents enables automated processing workflows that systematically apply multiple adjustment factors in a defined sequence, significantly reducing errors that may occur when such adjustments are performed manually or through disconnected processing steps.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages will be apparent to those skilled in the art from consideration of the specification and practice of the embodiments disclosed herein. The specification and examples should be considered exemplary.

What is claimed is:

1. A computer-implemented system for implementing a contract leakage detection and analysis platform, the system comprising:
an input coupled to one or more sources;
a memory component that stores and manages contracts and invoices relating to one or more service providers; and
a computer server comprising a computer processor and coupled to the input and the memory component, the computer processor configured to perform the steps of:
extracting, via the input, pricing information from an invoice stored in a first document format to identify an invoice price, wherein extracting the pricing information comprises parsing the invoice to identify line items, quantities, and unit prices from the first document format;
retrieving, via the input, pricing data from an associated contract stored in a second document format to identify a contract price, wherein retrieving the pricing data comprises applying a trained machine learning model to extract pricing terms from the second document format;
determining whether the invoice price is equivalent to the contract price by comparing the extracted invoice price against the retrieved contract price;
applying an invoice discrepancy investigation agent that is configured to:
apply a check for a pricing change order and amendment from the associated contract and determine whether an adjusted contract price applies, wherein the check comprises parsing change order documents to extract effective dates and revised pricing terms;
apply a check for an inflation clause in the associated contract and determine whether a recalculated adjusted contract price applies, wherein the check comprises initiating an application programming interface call to an external data source to retrieve a current inflation rate;
apply a check for an exchange rate and determine whether a recalculated adjusted contract price applies, wherein the check comprises initiating an application programming interface call to an external data source to retrieve a current exchange rate; and
apply a check for volume-based discounts specified in the associated contract and determine whether discount adjustments apply;
applying an adjudication agent to normalize the contract price by applying one or more change order adjustments, inflation adjustments, and exchange rate conversions in a defined sequence, and re-compare the normalized contract price to the invoice price; and
providing an interactive user interface that identifies one or more flagged items that represent a potential discrepancy and a reason for the potential discrepancy.

2. The computer-implemented system of claim 1, wherein the invoice discrepancy investigation agent is further configured to initiate an application programming interface call to an external source to retrieve an inflation rate when the inflation clause is identified in the associated contract.

3. The computer-implemented system of claim 2, wherein the invoice discrepancy investigation agent is further configured to evaluate a contract age to determine a cumulative inflation adjustment to apply based on the retrieved inflation rate.

4. The computer-implemented system of claim 1, wherein the invoice discrepancy investigation agent is further configured to initiate an application programming interface call to an external source to retrieve an exchange rate when the associated contract specifies a foreign currency.

5. The computer-implemented system of claim 4, wherein the invoice discrepancy investigation agent is further configured to evaluate an exchange rate period or date specified in the associated contract to determine an applicable exchange rate for recalculating the adjusted contract price.

6. The computer-implemented system of claim 1, wherein the adjudication agent is configured to:
apply one or more change order adjustments from the invoice discrepancy investigation agent;
apply one or more inflation adjustments from the invoice discrepancy investigation agent; and
apply one or more exchange rate conversions from the invoice discrepancy investigation agent to generate the normalized contract price.

7. The computer-implemented system of claim 1, wherein the interactive user interface is further configured to display invoices that have passed verification when the invoice price equals the normalized contract price.

8. The computer-implemented system of claim 1, further comprising a document classification and extraction service configured to classify incoming documents into document types and extract pricing terms from the contracts.

9. The computer-implemented system of claim 1, further comprising an artificial intelligence and machine learning engine configured to analyze training data from prior contracts to develop models that refine detection and analysis of contract leakage.

10. The computer-implemented system of claim 1, wherein the interactive user interface is further configured to display a severity level, a status, and a monetary amount associated with each flagged item.

11. A computer-implemented method for implementing a contract leakage detection and analysis platform, the method comprising the steps of:
extracting, via the input, pricing information from an invoice stored in a first document format to identify an invoice price, wherein extracting the pricing information comprises parsing the invoice to identify line items, quantities, and unit prices from the first document format;
retrieving, via the input, pricing data from an associated contract stored in a second document format to identify a contract price, wherein retrieving the pricing data comprises applying a trained machine learning model to extract pricing terms from the second document format;
determining whether the invoice price is equivalent to the contract price by comparing the extracted invoice price against the retrieved contract price;
applying an invoice discrepancy investigation agent that is configured to:
apply a check for a pricing change order and amendment from the associated contract and determine whether an adjusted contract price applies, wherein the check comprises parsing change order documents to extract effective dates and revised pricing terms;
apply a check for an inflation clause in the associated contract and determine whether a recalculated adjusted contract price applies, wherein the check comprises initiating an application programming interface call to an external data source to retrieve a current inflation rate;
apply a check for an exchange rate and determine whether a recalculated adjusted contract price applies, wherein the check comprises initiating an application programming interface call to an external data source to retrieve a current exchange rate; and
apply a check for volume-based discounts specified in the associated contract and determine whether discount adjustments apply;
applying an adjudication agent to normalize the contract price by applying one or more change order adjustments, inflation adjustments, and exchange rate conversions in a defined sequence, and re-compare the normalized contract price to the invoice price; and
providing an interactive user interface that identifies one or more flagged items that represent a potential discrepancy and a reason for the potential discrepancy.

12. The computer-implemented method of claim 11, wherein the invoice discrepancy investigation agent is further configured to initiate an application programming interface call to an external source to retrieve an inflation rate when the inflation clause is identified in the associated contract.

13. The computer-implemented method of claim 12, wherein the invoice discrepancy investigation agent is further configured to evaluate a contract age to determine a cumulative inflation adjustment to apply based on the retrieved inflation rate.

14. The computer-implemented method of claim 11, wherein the invoice discrepancy investigation agent is further configured to initiate an application programming interface call to an external source to retrieve an exchange rate when the associated contract specifies a foreign currency.

15. The computer-implemented method of claim 14, wherein the invoice discrepancy investigation agent is further configured to evaluate an exchange rate period or date specified in the associated contract to determine an applicable exchange rate for recalculating the adjusted contract price.

16. The computer-implemented method of claim 11, wherein the adjudication agent is configured to:
apply one or more change order adjustments from the invoice discrepancy investigation agent;
apply one or more inflation adjustments from the invoice discrepancy investigation agent; and
apply one or more exchange rate conversions from the invoice discrepancy investigation agent to generate the normalized contract price.

17. The computer-implemented method of claim 11, wherein the interactive user interface is further configured to display invoices that have passed verification when the invoice price equals the normalized contract price.

18. The computer-implemented method of claim 11, further comprising the step of:
classifying, via a document classification and extraction service, incoming documents into document types and extract pricing terms from the contracts.

19. The computer-implemented method of claim 11, further comprising the step of:
analyzing, via an artificial intelligence and machine learning engine, training data from prior contracts to develop models that refine detection and analysis of contract leakage.

20. The computer-implemented method of claim 11, wherein the interactive user interface is further configured to display a severity level, a status, and a monetary amount associated with each flagged item.
